(19) United States
(12) Patent Application Publication
(10) Pub. No.: US 2009/0327210 A1
(43) Pub. Date: Dec. 31, 2009

(54) ADVANCED BOOK PAGE CLASSIFICATION ENGINE AND INDEX PAGE EXTRACTION

(75) Inventor: ZHEN LIU, REDMOND, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/163,639

(22) Filed: Jun. 27, 2008

(51) Int. Cl. G06F 17/30

(52) U.S. Cl. 707/1; 707/E17.001

(57) ABSTRACT

Embodiments of the present invention relate to classifying pages of an electronic document, such as a scanned book page. An algorithm, such as a constrained conditional random fields algorithm, is applied to the contents of the electronic document to determine the type of page the electronic document is. Page types may include table of contents (TOC), index, table of figures (TOF), bibliography, epilogue, prologue, foreword, glossary, or other types of pages typically found in a book, magazine, or other publication. Once determined, the contents of the page are extracted using the same algorithm, and labeled.

### BACKGROUND

The Internet has evolved into a communication medium capable of delivering virtually any type of media in electronic form. One particular media that is becoming increasingly digitized is the written word. Books, magazines, articles, and other publications are currently being stored as digital files that can easily be downloaded and viewed on electronic devices. No longer must consumers haul around paper copies of their favorite books. Now, they can peruse online libraries containing a vast quantity of digital publications.

Often, it is difficult to locate a digital form of a publication. Scanning publications using modern scanning devices is one method of creating an electronic version of a printed publication. During scanning, an image of one or more printed pages is extracted from the document and stored in a data file. Extracting and labeling pages from the document may prove useful, including identifying the index pages of the document. An index page, in particular, can be used to build key word lists and phrases that may be employed to improve relevance in book searches.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to classifying pages of an electronic document, such as a scanned book page. An algorithm, such as a constrained conditional random fields algorithm, is applied to the contents of the electronic document to determine the type of page the electronic document is. Page types may include table of contents (TOC), index, table of figures (TOF), bibliography, epilogue, prologue, foreword, glossary, or other types of pages typically found in a book, magazine, or other publication. Once determined, the contents of the page are extracted using the same algorithm, and labeled.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary page classification and extraction system, in accordance with an embodiment of the present invention; and

FIG. 3 is a flow diagram illustrating an exemplary method for labeling a page in an electronic document, in accordance with an embodiment of the present invention.

### DETAILED DESCRIPTION

The subject matter of the present invention is described with specificity herein to meet statutory requirements. The description itself is not intended, however, to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to classifying pages of an electronic document, such as a scanned book page. An algorithm, such as a constrained conditional random fields algorithm, is applied to the contents of the electronic document to determine the type of page the electronic document is. Page types may include table of contents (TOC), index, table of figures (TOF), bibliography, epilogue, prologue, foreword, glossary, or other types of pages typically found in a book, magazine, or other publication. Once determined, the contents of the page are extracted using the same algorithm, and labeled. Embodiments described herein refer to the above types of pages; however, the invention is not limited thereto. Rather, similar page types may be determined by the embodiments described herein.

Accordingly, in one embodiment, the present invention includes a computer system for labeling and extracting content from one or more pages from a books, wherein each book includes a plurality of types of pages. The computer system comprises, in part, a page type classifying component configured to classify the type of book page based on a plurality of features for each type of page using a constrained conditional random fields algorithm; an extracting component configured to extract content from the book page using the algorithm, where the extraction of content is based upon the type of book page; and a labeling component configured to label the extracted content.

Another embodiment of the present invention is directed toward a method for determining a page type of a portion of an electronic document. An OCR file associated with the portion of the electronic document is received; wherein, the OCR file includes semantic information about text in the portion of the electronic document. A portion of the semantic information is analyzed by applying one or more features to the semantic information. Based on the application of the one or more features, a page type can be determined for the portion of the electronic document. And once determined, an indication of the page type can be stored.

Another embodiment of the present invention is directed toward a computerized method for labeling and extracting items from one or more pages from a book, where each book includes a plurality of types of pages. The method comprises, in part, classifying the type of book page based on a plurality of assigned features for each type of page using a constrained conditional random fields algorithm, where the relationship between each book page is used to classify the book page; extracting content from the book page using the constrained conditional random fields algorithm, where the extraction of content is based upon the type of book page; determining whether the extracted content has been accurately classified, and if not, correcting the feature in the algorithm on which the classification error was based; labeling the extracted content; and presenting the labeled content.

Having briefly described an overview of embodiments of the present invention, an exemplary operating environment suitable for implementing the present invention is described below.

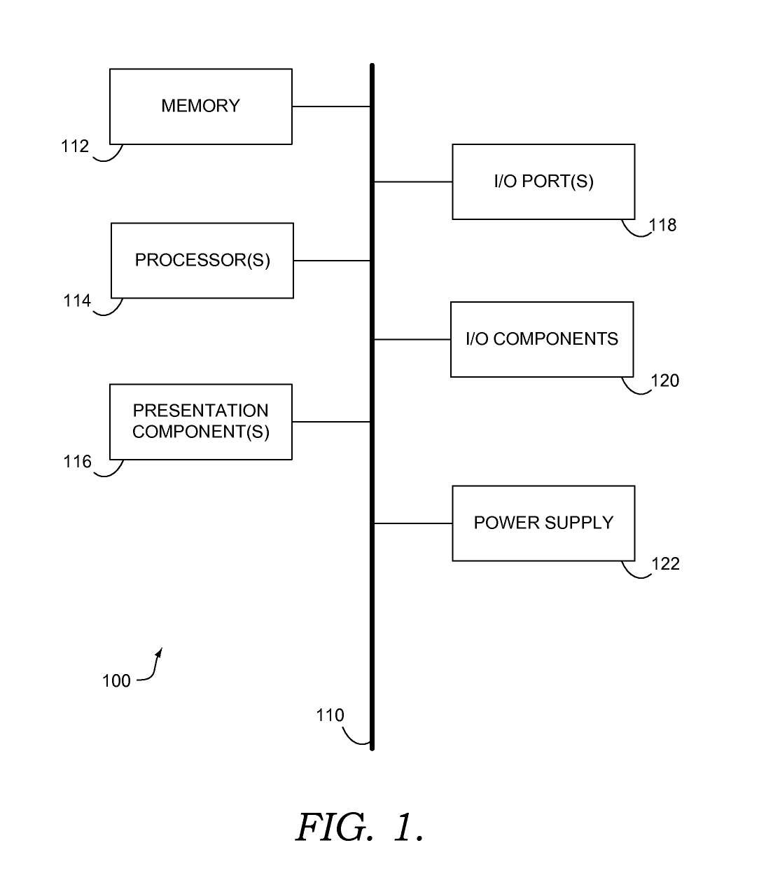

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. Embodiments of the present invention may be practiced in a variety of system configurations, including hand-held devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

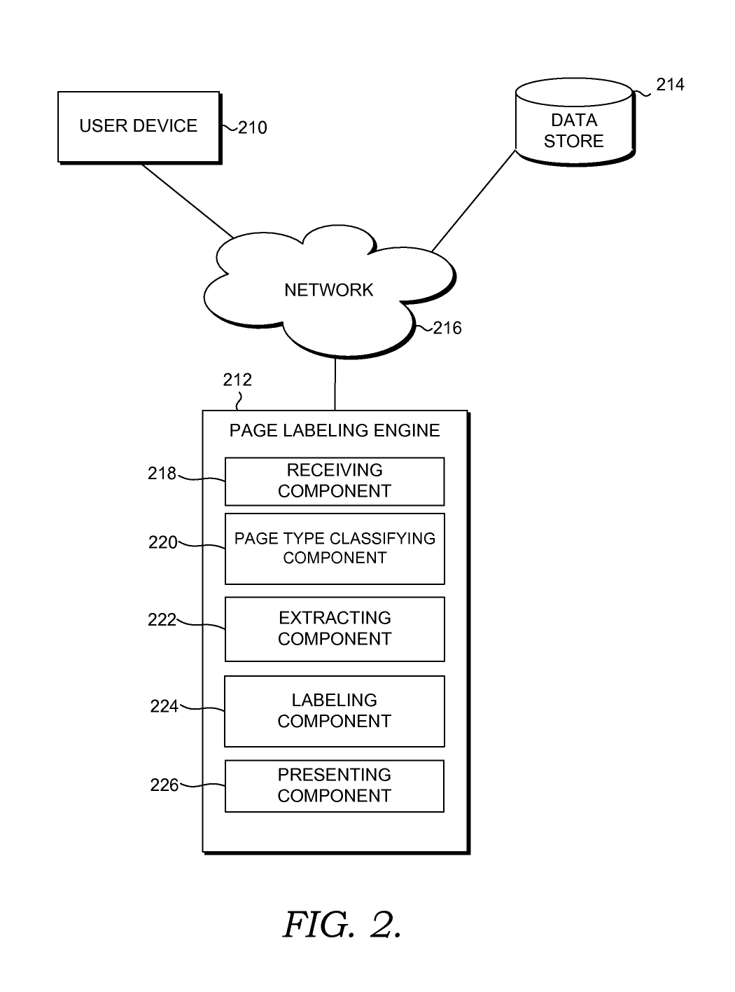

Turning now to FIG. 2, a block diagram is illustrated showing an exemplary page labeling engine 212 configured to label items on a book page, in accordance with an embodiment of the present invention. It will be understood and appreciated by those of ordinary skill in the art that the page labeling engine 212 shown in FIG. 2 is merely an example of one suitable computing environment and is not intended to suggest any limitation as to the scope of use or functionality of the present invention. Furthermore, page labeling system 200 should not be interpreted as having any dependency or requirement related to any single component or combination of components illustrated therein. In one embodiment, the page labeling system 200 is incorporated into a stand-alone product, as part of a page classifying software package, as a part of a document layout extraction software package, or any combination thereof.

Computing system 200 includes a page labeling engine 212, a user device 210, and a data store 214 all in communication with one another via a network 216. The network 216 may include, without limitation, one or more local area networks (LANs) and/or wide area networks (WANs). Such networking environments are commonplace in offices, enterprise-wide computer networks, intranets, and the Internet. Accordingly, the network 216 is not further described herein.

The data store 214 may be configured to store information associated with various types of content, as more fully described below. It will be understood and appreciated by those of ordinary skill in the art that the information stored in the data store 214 may be configurable and may include any information relevant to online content. Further, though illustrated as a single, independent component, data store 214 may, in fact, be a plurality of data stores, for instance, a database cluster, portions of which may reside on a computing device associated with the page labeling engine 212, the user device 210, another external computing device (not shown), and/or any combination thereof.

Each of the page labeling engine 212 and the user device 210 shown in FIG. 2 may be any type of computing device, such as, for example, computing device 100 described above with reference to FIG. 1. By way of example only and not limitation, the page labeling engine 212 and/or the user device 210 may be a personal computer, desktop computer, laptop computer, handheld device, mobile handset, consumer electronic device, and the like. It should be noted, however, that the present invention is not limited to implementation on such computing devices, but may be implemented on any of a variety of different types of computing devices within the scope of the embodiments hereof.

As shown in FIG. 2, the page labeling engine 212 includes a receiving component 218, a monitoring component 220, a compiling component 222, a delivering component 224, and a presenting component 226. In some embodiments, one or more of the illustrated components 218, 220, 222, 224, and 226 may be implemented as stand-alone applications. In other embodiments, one or more of the illustrated components 218, 220, 222, 224, and 226 may be integrated directly into the operating system of the page labeling engine 212 or the user device 210. In the instance of multiple servers, embodiments of the present invention contemplate providing a load balancer to federate incoming queries to the servers. It will be understood by those of ordinary skill in the art that the components 218, 220, 222, 224, and 226 illustrated in FIG. 2 are exemplary in nature and in number and should not be construed as limiting. Any number of components may be employed to achieve the desired functionality within the scope of the embodiments of the present invention. In some embodiments, the page labeling engine 212 further includes an advertising system 228. The advertising system 228, as the other illustrated components of the page labeling engine 212, may be implemented as a stand-alone application or may be integrated directly into the operating system of the page labeling engine 212.

The receiving component 218 is configured for receiving content, such as pages in an electronic document or other format. More specifically, electronic documents may include, without limitation, scanned pages, or pages in an electronic format (e.g., portable document format (PDF), etc.) Books, magazines, or other documents may be stored in an electronic format, such as when they are scanned by a scanner. Once received by the receiving component 218, the content may be stored, for instance, in association with data store 214, such that it is searchable to determine satisfaction of a user query, as more fully described below. Such received content may additionally be indexed, if desired.

The page type classifying component 220 is configured for classifying a page as a type of page. Types of pages may include, by way of example without limitation, a TOC, index, bibliography, table of figures, prologue, epilogue, glossary, foreword, or similar page. Embodiments described herein refer to the above types of pages; however, the invention is not limited thereto. Rather, similar page types may be determined by the embodiments described herein.

More particularly, the page type classifying component 220 will take a received page and will, using various embodiments of methods described herein, classify the page type of the page. Various methods may be used; however in one embodiment, constrained conditional relational fields (CCRF) are used. Such an algorithm can automatically label a sequence of context, such as a sequence of pages or words, in the page. As is known in the art, the use of a CCRF includes a training phase and an employing phase. During the training phase, the algorithm is exposed with manually labeled data. The manually labeled data includes, for example, features present in each type of page.

When looking at each individual page, manually labeled data related to a TOC page might include: pages that contain the words “content”, “table of contents,” “page”, chapter”, etc.; words at the top of the page in a large font; a high percentage of lines ending in numbers; whether the lines ending with numbers form an ordered list; the number of lines with separators between the text and number; and the word “index” as the last word on the page.

If the page is an author page, the algorithm might be manually trained to look for: pages containing words, such as “author, “authors”, “about the authors”, etc. at the beginning of the page; a high percentage of sentences starting with a pronoun (e.g., he, she, he, his).

To determine whether a page should be classified as a bibliography page type, the algorithm will look for: a high percentage of lines ending with a number; a high percentage of lines containing a pattern, such as NN-NN; a high percentage of lines containing a number representative of a year (e.g, XX/XX/XXXX); a number of capitalized characters followed by a period; and a number of single characters in the text.

For an index page, the algorithm may reference several features known of index pages, including: whether the word “index” is the first word in a page and/or is in a large font; the percentage of lines ending with a number; the average number of words in a line; a number of patterns, such as NN-NN; and a number of lines that contain numbers in an ordered sequence.

One will appreciate that the above features of each type of page are only illustrative, and are not intended to exclusively describe the invention.

In addition to each individual page, the page type classifying component 220 may also use the relationship between pages in determining the classification of a page type. For example, to help determine the end of a content or text page, a feature may be entered in the algorithm, such as whether the word “index” is the last word on a current page and “chapter” is the first word of the next page. In another example, to help force a page between two index pages is an index page, a feature may include (1) if the previous page has an average of three words in a line and contains 90% of lines ending with a number; and (2) if the next page has an average of three words in a line and contains 90% of lines ending with a number.

In embodiments using the CCRF, after the training phase using the manually entered data, such as the features listed above, the trained algorithm is applied to new unlabeled data in order to automatically label the data and, in turn, classify the page type.

The extracting component 222 is configured for extracting the information from the page, which will be dependent upon which type of page was classified. Thus, extraction will be different for each type of page. Notably, after extraction of page content, the system 200 may identify classification errors, and if errors have occurred, may provide feedback to the algorithm as a constraint. Accordingly, the algorithm can recomputed the labels which fit the constraint. By way of example, without limitation, if the extracted target pages for a TOC page are not the start of chapters, or the extracted target pages for index pages do not contain the index items, a classification error may have occurred.

The same algorithm may be used for the extracting performed on each page, as the algorithm used to classify the page type. To extract content, a layout analysis is conducted on each page to remove rare font size words, remove headers and footers, detect the indent level, and the like. By way of example, without limitation, detecting the indent level for a labeled index page, the columns on the page are first separated. Then, the common line indent is computed with some variance, such as five pixels. The line indent is then divided into groups.

The divided lines that are to the furthest left on the page are the first level items. Examining the first level items, the alphabetic start of these main index items is estimated. If the indent contains a line with another starting character other than those main index items, the indent is a second level item. Repeating this process results in third level indent.

The labeling component 224 is configured to label the extracted content from the page. As with the extraction process, the labeling component 224 will use a different method for each type of page. Continuing the discussion of an index page from the extraction step, various labels may be applied to the content of an index page, generally based on the determined indent level.

The presenting component 226 is configured for presenting at least one targeted advertising unit based on the user's activity. Typically such presentation will be by way of display in associations with a user interface. However, other forms of presentation, including audio presentation and audio/video presentation, are contemplated to be within the scope of embodiments hereof.

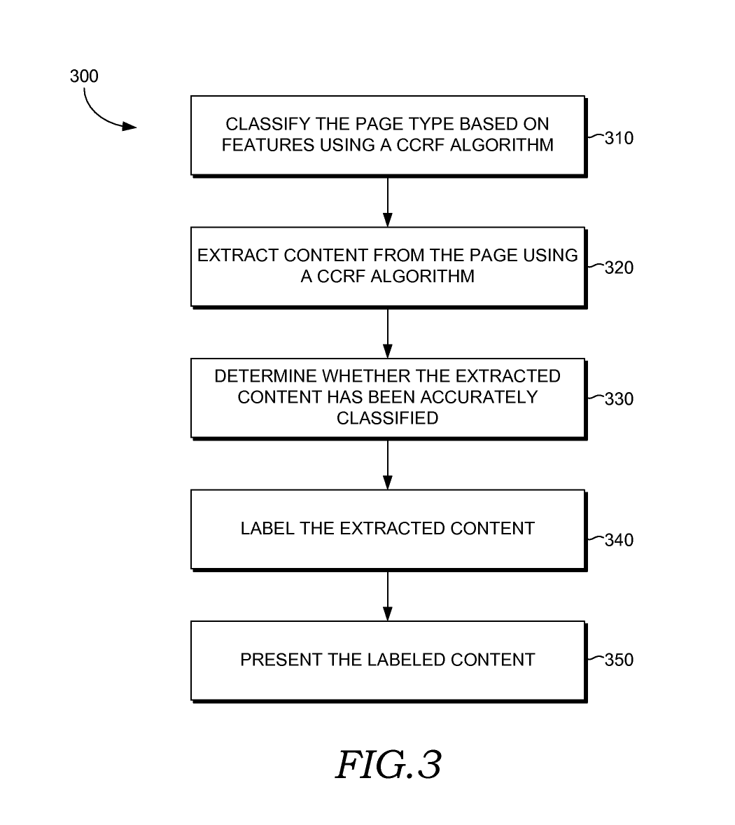

Turning now to FIG. 3, an exemplary method 300 for labeling and extracting content from a book page is illustrated. Initially, as indicated at block 310, the page is classified by type based on specific assigned features. The classification is performed using an algorithm, such as a CCRF, that has manually received the specific assigned features, on which the classification is based. The assigned features are dependent on the type of page, as was discussed above with respect to FIG. 2.

Next, at block 320, based on the page type classification, the content is extracted from the page using an algorithm, such as a CCRF. At this point, it is determined whether the page classification was accurate, as shown at block 330. If not, the feature that caused the incorrect classification in the algorithm is corrected. Providing such feedback ensures a more accurate general process. Once the correct page classification has occurred and the content extracted, the extracted content is labeled at block 340. And, at block 350, the labeled content is presented (e.g., utilizing the presenting component 226 of FIG. 2).

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer-storage media having computer-executable instructions embodied thereon that, when executed, perform a method for labeling and extracting items from one or more pages from a book, wherein each book includes a plurality of types of pages, the method comprising:
classifying the type of book page based on a plurality of features for each type of page using a constrained conditional random fields algorithm;
extracting content from the book page using the constrained conditional random fields algorithm, wherein the extraction of content is based upon the type of book page;
labeling the extracted content; and
presenting the labeled content.

2. The media of claim 1, wherein the plurality of features is manually entered into the algorithm.

3. The media of claim 1, wherein the plurality of features for an index page includes a page with the term “index” at the beginning of the page.

4. The media of claim 1, wherein the plurality of features for an index page includes a page with at least 80% of the lines ending with a number.

5. The media of claim 1, wherein the plurality of features for an index page includes a page with a number of lines in an ordered sequence.

6. The media of claim 1, wherein the plurality of features for a TOC page includes a page containing the term “content”.

7. The media of claim 1, wherein the plurality of features for a TOC page includes a page with the majority of lines ending with a number.

8. The media of claim 1, wherein the method performed further includes determining whether the page has been classified correctly, and if not, manually correcting the feature in the algorithm that relates to the error.

9. A computer system for labeling and extracting content from one or more pages from a books, wherein each book includes a plurality of types of pages, the computer system comprising:
a page type classifying component configured to classify the type of book page based on a plurality of features for each type of page using a constrained conditional random fields algorithm;
an extracting component configured to extract content from the book page using the algorithm, wherein the extraction of content is based upon the type of book page; and
a labeling component configured to label the extracted content.

10. The computer system of claim 9, further comprising a presenting component configured to present the labeled content.

11. The computer system of claim 9, wherein the extracting component is further configured to determine whether the book page has been correctly classified by the page type classifying component.

12. The computer system of claim 11, wherein if the book page has been classified incorrectly, manually correcting the algorithm.

13. The computer system of claim 9, wherein the book page is classified as an index page.

14. The computer system of claim 9, wherein the book page is classified as a TOC page.

15. A computerized method for labeling and extracting items from one or more pages from a book, wherein each book includes a plurality of types of pages, the method comprising:
classifying the type of book page based on a plurality of assigned features for each type of page using a constrained conditional random fields algorithm, and wherein the relationship between each book page is used to classify the book page;
extracting content from the book page using the constrained conditional random fields algorithm, when the extraction of content is based upon the type of book page;
determining whether the extracted content has been accurately classified, and if not, correcting the feature in the algorithm on which the classification error was based;
labeling the extracted content; and
presenting the labeled content.

16. The method of claim 15, wherein the plurality of features is manually entered into the algorithm.

17. The method of claim 15, wherein the plurality of features for an index page includes a page with the term “index” at the beginning of the page.

18. The method of claim 15, wherein the plurality of features for an index page includes a page with at least 80% of the lines ending with a number.

19. The method of claim 15, wherein the plurality of features for an index page includes a page with a number of lines in an ordered sequence.

20. The method of claim 15, wherein the book page is classified as an index page.
